(19) United States
(12) Patent Application Publication
(10) Pub. No.: US 2008/0170411 A1
(43) Pub. Date: Jul. 17, 2008

(54) LIGHT OCCLUDING APPARATUS AND METHOD

(76) Inventors: Gary Fails, Tappan, NY (US); Lauren Dunn, New York, NY (US); Benjamin Merrick, Hamden, CT (US); Michael Baldassari, Hoboken, NJ (US)

Correspondence Address: John P. Maldjian, Esq.;Moser IP Law Group, 2nd Floor, 1040 Broad Street, Shrewsbury, NJ, 07702, US

(21) Appl. No.: 11/550,665

(22) Filed: Oct. 18, 2006

(51) Int. Cl. F21V 7/04

(52) U.S. Cl. 362/605

(57) ABSTRACT

Embodiments of the present invention generally relate to light occluding devices and methods. In one embodiment of the present invention, a light occluding device comprises a tapered sidewall extending from a first end having a first diameter to a second end having a second diameter, and a base. The base comprises a step ring having a uniform diameter greater than the first diameter of the tapered sidewall, and an optional flange fixed to a second end of the step ring, radially extending out from a center of the light occluding device. A shoulder is defined by an intersection of a first end of the step ring and the first end of the sidewall, and the first diameter of the first end of the sidewall is greater than the second diameter of the second end of the sidewall.

### BACKGROUND OF THE INVENTION

1. Field of the Invention

Embodiments of the present invention generally relate to light occluding devices and methods, and in particular, devices and methods for use in the lighting industry

2. Description of the Related Art

Light occluding devices, commonly referred to as “top hats”, are used in lighting design and control in conjunction with conventional lighting fixtures. Light occluding devices are most commonly employed in theaters, theme parks, movie sets, television studios, lighting rental shops, architectural lighting, event lighting, and the like, to prevent audiences or cameras from seeing a misdirected bright source of light when a spot light or other lighting fixture is on and to control spill light. Traditional top hats comprise a cylindrical sidewall, an open top, and an open bottom having a flared edge that extends outwardly from the sidewall. These top hats are generally made from cold-rolled steel and are spot welded together. The manufacturing process is time-consuming and involves three to five processing steps.

The cylindrical sidewall of a traditional top hat extends from the open top to the open bottom. The open top has a diameter that is substantially identical to the open bottom diameter, thus yielding a constant diameter through the sidewall of the top hat. The sidewall is generally a height substantially identical to the diameters of the open top and open bottom. This dimensional feature provides a 45 degree blocking angle, i.e., no light is visible from the light source outside of 45 degrees from the center of the light source.

The flared edge is spot welded to the sidewall along the open bottom, and extends outwardly from the sidewall. Generally, the flared edge is square, formed with hemmed sections folded back over a bottom surface of the edge. These hemmed sections provide reinforced strength to the flared edge and generally align with a slot in a lighting fixture. A variety of lighting fixtures, for example, a spot light, a stage light, or the like, are used in conjunction with traditional top hats. Typically, a top hat is secured to the lighting fixture by sliding the flared edge of the top hat through a slot on the lighting fixture adjacent the light source. For example, when a top hat is used in conjunction with a spot light, a slot for attaching a top hat is provided adjacent to the lens of the spot light.

When traditional top hats are positioned in a lighting fixture, there is little to no rotational movement of the top hat within the slot of the lighting fixture because of the square-shaped flared edge. Furthermore, the square-shaped flared edge limits the possible rotational placement of the top hat to ninety degree intervals. This structural limitation has a significant impact on top hats having sections of their sidewall open (e.g., a top hat having only a semi-cylindrical sidewall).

Space is very limited in the backstage area of theatres, sound stages, television studios, and the like. Therefore, it is difficult to store accessories such as top hats when not in use. The cylindrical shape of a traditional top hat generally provides a top diameter substantially identical to an open diameter. Thus, it is physically difficult for one top hat to be stacked on top of another. As such, a theatre, movie set, or the like, is required to provide ample storage space for these devices when they are not in use. Storage space is of particular concern to end users because many users may require dozens, if not hundreds, of top hats in one production. Therefore, many end users store top hats in a pile in a storage room or other unorganized fashion. This often causes the top hats to bend, scratch, etc.

Thus, there is a need in the industry for a light occluding device that is stackable and does not seize. There is also a need in the industry for a light occluding device that is freely rotatable while in operation. There is also a need in the industry for an efficient method of making a light occluding device.

### SUMMARY

Embodiments of the present invention generally relate to light occluding devices and methods. In one embodiment of the present invention, a light occluding device comprises a tapered sidewall extending from a first end having a first diameter to a second end having a second diameter, and a base. The base comprises a step ring having a uniform diameter greater than the first diameter of the tapered sidewall, and an optional flange fixed to a second end of the step ring, radially extending out from a center of the light occluding device. A shoulder is defined by an intersection of a first end of the step ring and the first end of the sidewall, and the first diameter of the first end of the sidewall is greater than the second diameter of the second end of the sidewall.

In another embodiment of the present invention, a stack of light occluding devices comprises providing a plurality of light occluding devices wherein at least the flange of a first light occluding device rests against the shoulder of a second light occluding device.

In yet another embodiment of the present invention, a method of making a light occluding device comprises spinning metal sheeting to form at least a first section having a linearly varying first and second diameter and a second section having a diameter greater than the first diameter of the first section.

### BRIEF DESCRIPTION OF THE DRAWINGS

Additional objects and features of embodiments of the present invention will be more readily apparent from the following detailed description and appended claims when taken in conjunction with the drawings, in which:

FIG. 1 depicts a perspective view of a light occluding device in accordance with one embodiment of the present invention;

FIG. 2 depicts a side plan view of the light occluding device of FIG. 1;

FIG. 3 depicts a bottom plan view of the light occluding device of FIG. 1;

FIG. 4 depicts a prospective view of the light occluding device in accordance with one embodiment of the present invention;

FIG. 5 depicts a cross-sectional view of a stack of an embodiment of light occluding devices in accordance with one embodiment of the present invention; and

FIG. 6 depicts a flow diagram of a method for making a light occluding device in accordance with one embodiment of the present invention.

### DETAILED DESCRIPTION

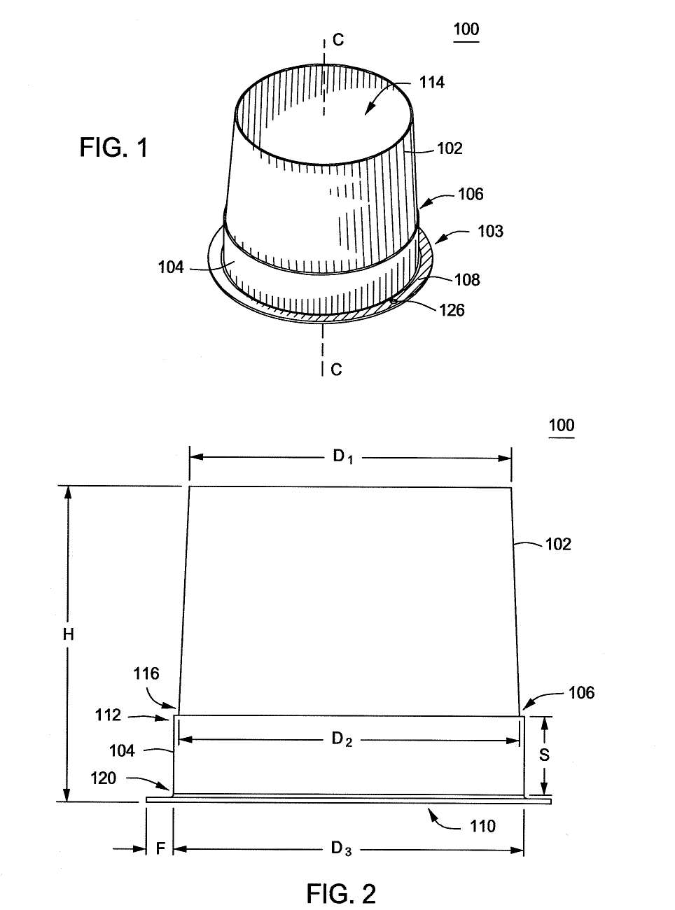

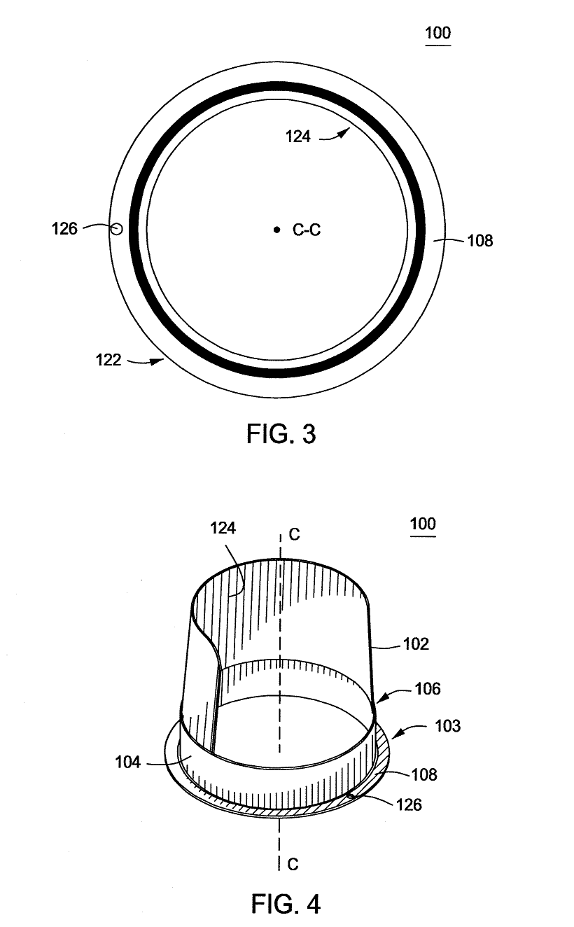

FIGS. 1-3 depict one embodiment of a light occluding device 100 in accordance with the present invention. A light occluding device 100, also known as a “top hat”, generally comprises a tapered sidewall 102 and a base 103. The base 103 generally comprises a step ring 104 having a constant diameter D₃ throughout its height S, and an optional flange 108 surrounding an open bottom 110. The base 103 extends from the open bottom 110 to a proximate end 112.

The proximate end 112 of the base 103 intersects with a proximate end 116 of the tapered sidewall 102 where a shoulder 106 is defined. The thickness of the shoulder 106 may be expressed as a function of subtracting the diameter of the bottom of the sidewall D₂ with the diameter of the step ring D₃.

The flange 108 is a thin washer-type ring fixed to a bottom end 120 of the step ring 104. The thickness of the flange F is dependent upon the lighting fixture (not shown) used in conjunction with the particular light occluding device 100. Most lighting fixtures employ a receiving slot (not shown) to fit a light occluding device 100. As such, the flange 108 may be sized to accommodate any lighting fixture. In one embodiment, the flange 108 has a circular outer perimeter 122. In other embodiments, the flange has a non-circular outer perimeter. For example, a flange 108 may have an outer perimeter 122 substantially in the shape of a circle, square, rectangle, triangle, or any other shape capable of being received by a lighting fixture having a receiving slot.

The tapered sidewall 102 extends from a proximate end 112 of the base 103 to an open top 114. The open top 114 of the light occluding device 100 has a diameter D₁ in a range between 0.01 inch and D₂, where D₂ is the diameter at the proximate end of the sidewall in inches. In one embodiment, diameter D₁ is a range between about 1 inches and about 48 inches. In another embodiment, diameter D₁ is about 5 inches. It is conceivable that D₁ and D₂ may be any size necessary to accommodate a lighting fixture.

The tapered sidewall 102 extends from the base 103 at an angle α. The angle α ranges from about 90 degrees to about 45 degrees. The angle α is determined by a predetermined height of the light occluding device H, the diameter of the open top D₁ and the height of the step ring S. In one embodiment, the diameter of the open top D₁ and the height of the light occluding device H are substantially equal. In this embodiment, the tapered sidewall angle α increases as the height of the step ring S increases.

In one embodiment of the present invention, an interior surface 124 of the light occluding device 100 is provided with a lining (not shown). The lining may be any material that enhances the performance of the light occluding device 100 by limiting the reflectivity and/or absorptivity of the interior surface 124. In one embodiment, the lining is a flocking or fleece material. In another embodiment, the lining may be textured plastic. Other embodiments of the present invention employ other materials including polymeric ribbed material, plastic coating, and the like.

In one embodiment of the present invention, an optional safety hole 126 is provided in the flange 108. The safety hole 126 provides a alternative means for securing the light occluding device 100. The safety hole 126 may be advantageous in situations where the light occluding device 100 is positioned above an audience and poses a safety risk.

FIG. 4 depicts a light occluding device in accordance with one embodiment of the present invention. In FIG. 4, one embodiment provides a tapered sidewall 102 that does not form a complete cylindrical shape, i.e., 360 degrees about the center axis C-C, due to having at least a radial portion thereof missing. For example, in one embodiment, a tapered sidewall extends 180 degrees about a center axis C-C (i.e., forming a semi-cylindrical sidewall). This embodiment may be advantageous where a light occluding device 100 is only necessary to inhibit a specific angle or range of angles from the light source. Examples of such situations include where an audience is positioned below a spot light in a theater, or where a stage light is positioned against a barrier, such as a wall. It is contemplated that the tapered sidewall 102 may extend from approximately 0 degrees to a complete 360 degree about a center axis C-C.

Other embodiments of the present invention provide a tapered sidewall 102 having sections thereof missing. For example, in one embodiment of the present invention, a tapered sidewall 102 may be missing a plurality of small shapes, such as stars. In another embodiment, a tapered sidewall 102 may be missing a crescent shape extending the entire length of the tapered sidewall 102. Other embodiments provide a tapered sidewall 102 having any portion thereof missing provided the light occluding device 100 remains structurally intact. These variations may be advantageous where a unique lighting pattern is desired from a lighting fixture.

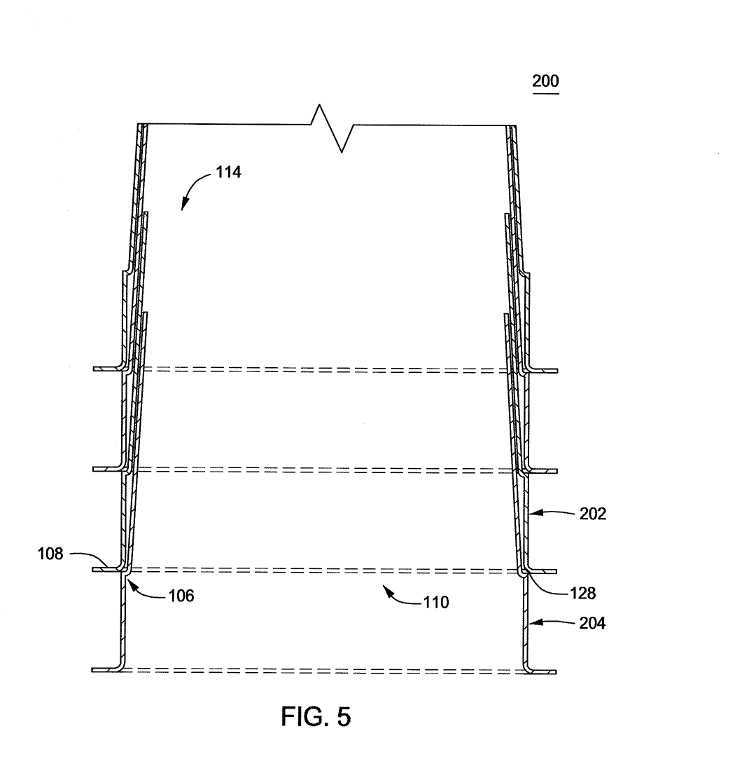

FIG. 5 depicts a cross-sectional view of a stack of light occluding devices 200 in accordance with one embodiment of the present invention. The light occluding devices 200 are stacked by placing the open bottom 110 of a second device 202 over the open top 114 of a first device 204. As the light occluding devices 200 are stacked, they remain at a separation distance equal to the height of the step ring S because the shoulder 106 of the first light occluding device 204 impedes the vertical motion of the second light occluding device 202. In one embodiment, an inner edge 128 of the flange 108 of the second light occluding device 202 rests against the shoulder 106 of the first light occluding device 204. In other embodiments, a set of tabs, an interior ring, or the like, may be provided on a second light occluding device 202 to rest against the shoulder 106 of the first light occluding device 204. Embodiments of the present invention provide sufficient stability for stacking light occluding devices 200, such that as many devices as necessary may be stacked on one another.

The light occluding device 100 of the present invention may be made by any conventional manufacturing process. In one embodiment, the light occluding device 100 is made by metal spinning. Examples of metals that may be used include aluminum, steel, copper, and the like. In other embodiments, forming processes may be used to manufacture the light occluding device 100, for example, stamping or deep drawing using steel or aluminum. In another embodiment, a light occluding device 100 is manufactured out of plastic, and may be dyed and textured to accommodate abovementioned features of aspects of embodiments of the present invention.

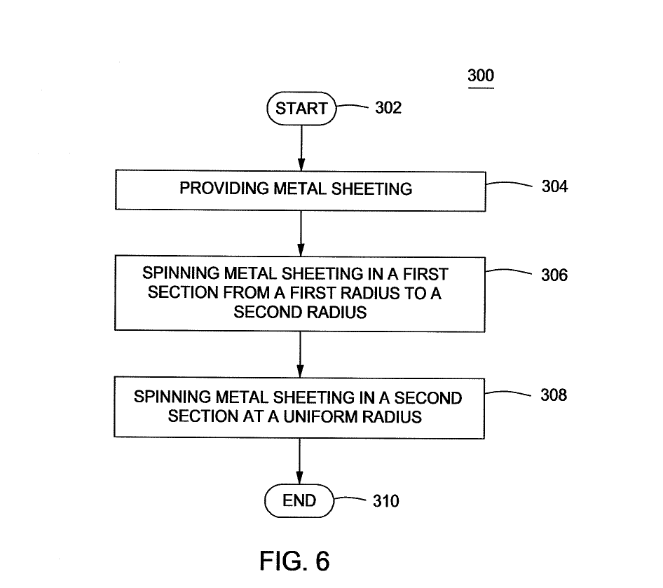

FIG. 6 depicts a flow diagram of a method for making a light occluding device in accordance with one embodiment of the present invention. The method 300 begins at step 302. At step 304, metal sheeting is provided to a mechanical lathe. In one embodiment, the metal sheeting is aluminum sheeting. At step 306, the metal sheeting is spun in a first section from a first radius to a second radius. In one embodiment, the metal sheeting is spun to yield a linear change in radius from the first radius to the second radius. At step 308, the metal sheeting metal sheeting is spun in a second section at a uniform radius. The second section of the metal sheeting begins immediately adjacent to the second radius of the first section and ends at a predetermined length. The uniform radius of the second section is greater than the second radius of the first section. The method 300 ends at step 310 at the creation of a light occluding device 100 in accordance with embodiments of the present invention.

While the foregoing is directed to embodiments of the present invention, other and further embodiments of the invention may be devised without departing from the basic scope thereof.

What is claimed is:

1. A light occluding device comprising:
a base having a uniform diameter extending from an open bottom to a proximate end;
a tapered sidewall extending from a first diameter at a proximate end to a second diameter at an open top;
a shoulder defined by an intersection of the proximate end of the base and the proximate end of the tapered sidewall; and
wherein the diameter of the of the base is greater than the first diameter at the proximate end of the tapered sidewall.

2. The light occluding device of claim 1, wherein the first diameter at the proximate end of the tapered sidewall is greater than the second diameter at the open top.

3. The light occluding device of claim 1, wherein the base further comprises a flange.

4. The light occluding device of claim 3, wherein an outer perimeter of the flange is substantially in the shape of one of a circle, square, rectangle, and a triangle.

5. The light occluding device of claim 1, wherein a height of the light occluding device is substantially equal to the second diameter at the open top.

6. The light occluding device of claim 1, wherein the tapered sidewall radially extends between about 90 degrees and 360 degrees about a center axis of the light occluding device.

7. The light occluding device of claim 6 wherein the tapered sidewall extends 360 degrees about the center axis of the light occluding device.

8. The light occluding device of claim 1, wherein the tapered sidewall is tapered at an angle between about 45 degrees and about 90 degrees.

9. The light occluding device of claim 1, wherein the second diameter at the open top is between about 1 inch and 48 inches.

10. The light occluding device of claim 9, wherein the second diameter at the open top is about 5 inches.

11. A stack of light occluding devices comprising:
a plurality of light occluding devices, wherein a light occluding device comprises:
a base having a uniform diameter extending from an open bottom to a proximate end;
a tapered sidewall extending from a first diameter at a proximate end to a second diameter at an open top;
a shoulder defined by an intersection of the proximate end of the base and the proximate end of the tapered sidewall; and
wherein the diameter of the of the base is greater than the first diameter at the proximate end of the tapered sidewall; and
wherein the base of a first light occluding device rests against the shoulder of a second light occluding device.

12. The stack of light occluding devices of claim 11, wherein the first diameter at the proximate end of the tapered sidewall of at least a light occluding device is greater than the second diameter at the open top of the light occluding device.

13. The stack of light occluding devices of claim 11, wherein the base of at least a light occluding device further comprises a flange.

14. The stack of light occluding devices of claim 13, wherein an outer perimeter of the flange of at least a light occluding device is substantially in the shape of one of a circle, square, rectangle, and a triangle.

15. The stack of light occluding devices of claim 11, wherein a height of at least a light occluding device is substantially equal to the second diameter at the open top of the light occluding device.

16. The stack of light occluding devices of claim 11, wherein the tapered sidewall of at least a light occluding device radially extends between about 90 degrees and 360 degrees about a center axis of the light occluding device.

17. The stack of light occluding devices of claim 11, wherein the tapered sidewall of at least a light occluding device is tapered at an angle between about 45 degrees and about 90 degrees.

18. The stack of light occluding devices of claim 11, wherein the second diameter at the open top of at least a light occluding device is between about 2 inches and 14 inches.

19. A method of making a light occluding device comprising the steps:
providing metal sheeting;
spinning metal sheeting in a first section from a first radius to a second radius; and
spinning metal sheeting in a second section at a uniform radius.

20. A method of claim 19, further comprising:
wherein the uniform radius of the second section is greater than the second radius of the first section; and
wherein the second radius of the first section is greater than the first radius of the first section.
